(19) United States
(12) Patent Application Publication
(10) Pub. No.: US 2011/0247767 A1
(43) Pub. Date: Oct. 13, 2011

(54) ROLL-UP BLIND WITH A BETTER SAFETY FEATURE

(76) Inventor: Ju-Chang CHEN, Taipei City (TW)

(21) Appl. No.: 12/817,541

(22) Filed: Jun. 17, 2010

(30) Foreign Application Priority Data
Apr. 9, 2010 (TW) 099206210

(51) Int. Cl. E06B 9/42

(52) U.S. Cl. 160/290.1

(57) ABSTRACT

A roll-up blind with a better safety feature includes a pore and a shed cloth. The pore is fixed at an end of the shed cloth which is provided on the pore. The shed cloth is provided with a first end surface and a second end surface, the first end surface is opposite to the second end surface and is provided with at least one male fastening tape; whereas, the second end surface is provided with at least one female fastening tape. Accordingly, through the shed cloth that is provided on the pore, the male fastening tapes on the first end surface can be fastened together with the female fastening tapes on the second end surface, such that the shed cloth can be rolled up.

### BACKGROUND OF THE INVENTION

a) Field of the Invention

The present invention relates to a roll-up blind and more particularly to a roll-up blind which utilizes a fastening effect with male fastening tapes and female fastening tapes to replace a conventional roll-up blind using a lift cord, thereby improving safety of use for the conventional roll-up blind.

b) Description of the Prior Art

Referring to FIG. 1, it shows a conventional roll-up blind which is formed primarily by a fixing mechanism A and a shed cloth B, wherein the fixing mechanism A includes a lift cord C which passes through the fixing mechanism A to connect with the shed cloth B, allowing the shed cloth B to be rolled up on the fixing mechanism A through an operation of the lift cord C.

In using the aforementioned conventional roll-up blind, the fixing mechanism A is fixed on a wall, allowing the lift cord C to be suspended on the fixing mechanism A; accordingly, the shed cloth B can be driven to be rolled up on the fixing mechanism A by pulling the lift cord C.

When using the aforementioned conventional roll-up blind, the lift cord C should be suspended on the fixing mechanism A that a user can pull the lift cord C easily. Nevertheless, this method is a hidden risk to home safety because when the lift cord C is not used, an end thereof is suspended on the fixing mechanism A and the other end passes through the fixing mechanism A to connect with the shed cloth B. Hence, the user, especially a child, can be easily hooked by the lift cord C accidentally. Additionally, the lift cord C can be hooked on a neck if one is not careful and it may be even fatal to the child.

Therefore, to solve the aforementioned issues, the present invention provides a roll-up blind which utilizes a fastening effect with male fastening tapes and female fastening tapes to replace a conventional roll-up blind using a lift cord, thereby improving safety of use for the conventional roll-up blind.

On the other hand, by this fastening effect, a length of the shed cloth can be adjusted to achieve convenience in use.

### SUMMARY OF THE INVENTION

The primary object of the present invention is to provide a roll-up blind which utilizes a fastening effect with male fastening tapes and female fastening tapes to replace a conventional roll-up blind using a lift cord, thereby improving safety of use for the conventional roll-up blind.

Specifically, a roll-up blind with a better safety feature, according to the present invention, includes a pore and a shed cloth. The pore is fixed at an end of the shed cloth which is provided on the pore. The shed cloth is provided with a first end surface and a second end surface. The first end surface is opposite to the second end surface and is provided with at least one male fastening tape; whereas, the second end surface is provided with at least one female fastening tape.

Accordingly, through the shed cloth that is provided on the pore, the male fastening tapes on the first end surface can be fastened together with the female fastening tapes on the second end surface, thereby achieving an effect of rolling up the shed cloth.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional roll-up blind.

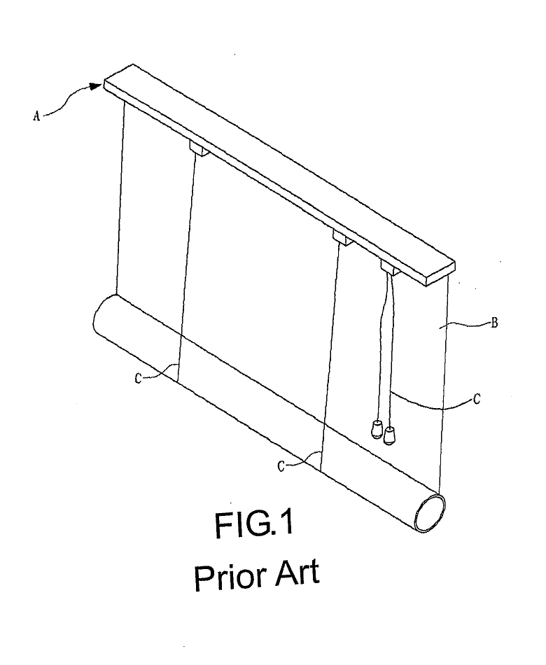

FIG. 2 shows a three-dimensional schematic view of a roll-up blind of the present invention.

FIG. 3 shows a cutaway view of the roll-up blind of the present invention.

FIG. 4 shows a schematic view of an operation of the roll-up blind of the present invention.

FIG. 5 shows a local blow-up view of FIG. 4.

FIG. 6 shows a schematic view of a second embodiment of the roll-up blind of the present invention.

### DETAILED DESCRIPTION OF THE PREFERRED EMBODIMENTS

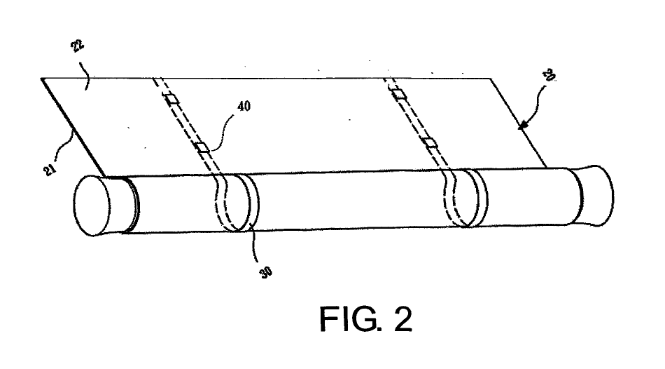

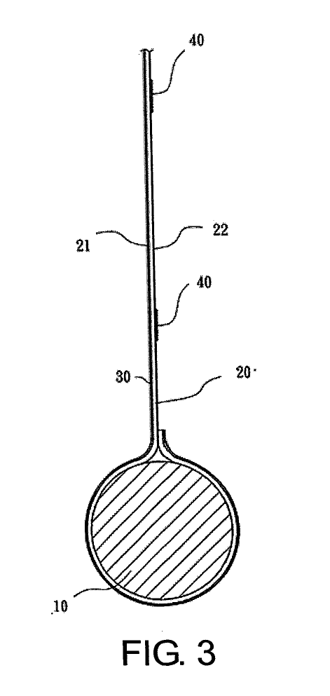

Referring to FIG. 2 and FIG. 3, it shows a three-dimensional schematic view and a cutaway view of a roll-up blind of the present invention. As shown in the drawings, the present invention comprises a pore 10 and a shed cloth 20, wherein the pore 10 is fixed at an end of the shed cloth 20 and the shed cloth 20 is provided on the pore 10 (no further description is disclosed as it belongs to an average technology).

The shed cloth 20 is provided on the pore 10 and is rolled up by the pore 10. Additionally, the shed cloth 20 is provided with a first end surface 21 and a second end surface 22, the first end surface 21 is opposite to the second end surface 22 and is provided with two rows of male fastening tapes 30 in a shape of stripes; whereas, the second end surface 22 is provided with two rows of female fastening tapes 40 which are arranged in spacing.

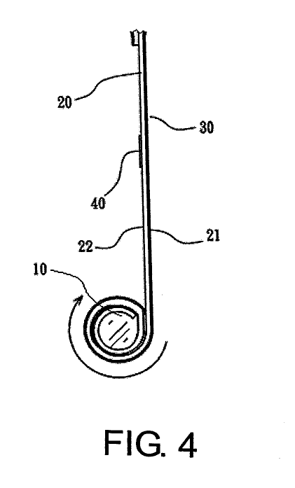

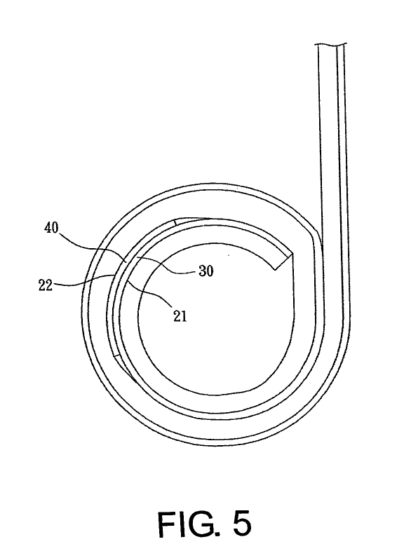

Referring to FIG. 4 and FIG. 5, it shows a schematic view and a local blow-up view of an operation of the roll-up blind of the present invention. As shown in the drawings, when the pore 10 is fixed at one end of the shed cloth 20, the shed cloth 20 can be rolled up clockwise from the pore 10 below, such that the shed cloth 20 that is provided on the pore 10 can be rolled up gradually. However, when the shed cloth 20 is rolled up gradually, the male fastening tapes 30 on the first end surface 21 and the female fastening tapes 40 on the second end surface 22 will be rolled up gradually, allowing the female fastening tapes 40 on the second end surface 22 to be fastened together with the male fastening tapes 30 on the first end surface 21, such that the shed cloth 20 can be rolled up and fixed.

Accordingly, through a simple fastening effect with the male fastening tapes 30 and the female fastening tapes 40, the shed cloth 20, as compared to the prior art, is provided with simpler structures, is safer to use, can be used without a lift cord and has a reduced cost. Therefore, the lift cord can be replaced and the safety of use for the conventional roll-up blind can be improved. In the aforementioned embodiment, the shed cloth 20 is rolled up by rotating the pore 10 clockwise; however, in a practical application, the shed cloth 20 can be also rolled up by rotating the pore 10 counterclockwise.

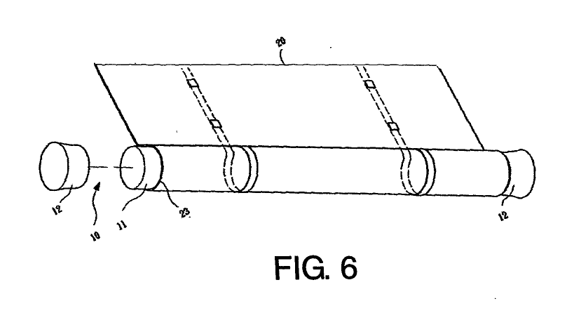

Referring to FIG. 6, it shows a schematic view of a second embodiment of the roll-up blind of the present invention. As shown in the drawing, the pore 10 is further constituted by a pore body 11 and two collars 12; whereas, the shed cloth 20 further includes a sheath part 23. After the pore body 11 has passed through the sheath part 23 on the shed cloth 20, the two collars 12 are sheathed at two ends of the pore body 11, so as to prevent the shed cloth 20 from slipping out of the pore body 11, thereby improving the safety of use for the entire conventional roll-up blind.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A roll-up blind with a better safety feature comprising:
a pore which is fixed on a shed cloth; and
the shed cloth which is provided on the pore and is provided with a first end surface and a second end surface, with the first end surface being opposite to the second end surface and being provided with at least one male fastening tape, whereas the second end surface being provided with at least one female fastening tape;
accordingly, through the shed cloth that is provided on the pore, the male fastening tapes on the first end surface being fastened together with the female fastening tapes on the second end surface, so as to roll up the shed cloth.

2. The roll-up blind with a better safety feature according to claim 1, wherein the pore is further provided with a pore body and two collars, the shed cloth is sheathed on the pore body and the two collars are sheathed respectively at two ends of the pore body.

3. The roll-up blind with a better safety feature according to claim 2, wherein the shed cloth is further provided with a sheath part through which the shed cloth is sheathed on the pore body of the pore, allowing the shed cloth to be provided on the pore.

4. The roll-up blind with a better safety feature according to claim 1, wherein the shed cloth is rolled up by rotating the pore clockwise.

5. The roll-up blind with a better safety feature according to claim 1, wherein the shed cloth is rolled up by rotating the pore counterclockwise.
